(19) United States
(12) Patent Application Publication
(10) Pub. No.: US 2006/0137621 A1
(43) Pub. Date: Jun. 29, 2006

(54) Heated cabana for pets

(76) Inventor: David Foresman, New York, NY (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/290,270

(22) Filed: Nov. 30, 2005

Related U.S. Application Data
(60) Provisional application No. 60/633,315, filed on Dec. 3, 2004.

(51) Int. Cl. A01K 1/03

(52) U.S. Cl. 119/482

(57) ABSTRACT

A heated cabana for a pet comprising: a housing having an entrance and an open floor area for the pet to rest; a mat situated on the floor and having a pressure activated switch therein; and a heat lamp system in electrical communication and switched on when the animal places its weight on the mat.

### CROSS-REFERENCE TO RELATED APPLICATIONS

This application claims benefit to Provisional Application No. 60/633,315, filed on Dec. 3, 2004, entitled “Heated Cabana for Pets,” which is incorporated by reference in its entirety herein.

### FIELD OF THE INVENTION

The present invention is directed to the field of sun/heat lamps, pressure activated switches, and pet beds. In particular, the present invention is directed to a pressure-activated heated pet bed.

### BACKGROUND OF THE INVENTION

Millions of people throughout the world keep pets such as dogs and cats. Frequently, these animals are kept out of doors or in colder sections of the house. Often this subjects the pet to colds, illness or discomfort. There have been a number of patents directed to the area of heated pet beds. U.S. Pat. No. 6,553,935 discloses a pet air bed that includes a plastic housing having a base portion and an elevated pet support portion hingedly connected to the base portion and having a number of air flow holes provided through pet support and/or pet adjacent surfaces thereof; a fan assembly being connected to the plastic housing in a manner such that air flow from the exterior of the plastic housing is generated into a cavity within the plastic housing in a manner to cause air to flow out through the air flow holes in the elevated pet support portion; the cavity formed within the plastic housing is provided for positioning cooling or heating elements such that the pet may have a temperature controlled pet bed; a forward section of the plastic housing including clips for holding a name tag or other pet identifying type of plate.

U.S. Pat. No. 6,465,761 discloses a reactor chamber, which is positioned between a top array of heat lamps and a bottom array of heat lamps. At least one of the heat lamps forming the top and bottom arrays features a segmented filament such that power output along the length of the heat lamp differs. In one configuration, the heat lamp has a pair of high energy output regions spaced from each other by a lower energy output region. In some configurations, at least one of the heat lamps forming the top and bottom arrays is non-linear, such as U-shaped. In further configurations, a non-linear heat lamp has a segmented filament with segments or areas of different winding density.

U.S. Pat. No. 6,237,531 discloses a lightweight, portable pet bed. It features an open structure with a hollow ring around its periphery. This ring can trap air which provides a thermal barrier for the pet. A thermoelectric unit is mounted to its underside with appropriate ducting for air circulation so that, depending on the electrical connection, heating or cooling is provided to a sink which is integral with the platform in the pet bed. The pet bed can also provide holes in the platform to secure an appropriate mat for the pet to lay on and to cover the sink which forms a part of the platform. A host of shapes are contemplated, including rectangular, round, oval, and the like. The thermoelectric or other heating or cooling unit can be manually controlled or thermostatically controlled. The units are stackable for easy storage or for shipping or display.

U.S. Pat. No. 5,796,059 discloses a pressure-sensitive switch apparatus for use in monitoring the position of a patient in a bed or chair is provided. The switch includes a resilient conductor disposed between first and second conductors located at opposite surface areas of the switch. The resilient conductor provides varying degrees of electrical contact between the first and second electrical conductors in response to pressure applied to either of these conductors by shifting of the patient's weight.

U.S. Pat. No. 4,172,216 discloses a resilient insulative layer of a plastic foam material is sandwiched between a dimpled carbon powder loaded plastic sheet and a resilient carbon powder loaded plastic foam pad. The dimples extend part way through holes provided therefore in the insulative layer. This sandwich assembly being placed under a bed mattress serves as a mattress-switch indicating electrically by contact between the sheet and the pad the presence of an occupant in the bed or his absence by lack of such contact. The characteristic time of the pad material for returning to its original shape is substantially longer than the corresponding return time of the insulative layer. Reliable operation is obtained for a wide range of occupant weights regardless of the weight(s) of the previous occupant.

While there have been heated pet beds, there has been a need for controllable systems for providing heat and light to pets.

It is an object of the present invention to provide a heated lamp and light for a pet such as a dog or cat.

It is a further object of the present invention to provide a light and heat lamp which is activated by the pet.

It is still a further object of the present invention to provide a system which controls the the heat according to a thermostat.

It is still a further object of the invention in which the heat is activated based upon the weight of the pet and which can be set based upon the weight of the pet.

It is still a further object of the to provide a

These and other objects of the invention will become apparent from the detailed description which follows.

### SUMMARY OF THE INVENTION

In accordance with the present invention, a heated area for a pet comprising; a housing having an entrance and an open floor area for the pet to rest; a mat situated on the open floor area and having a pressure activated switch therein for activating the area; and a heat lamp system in electrical communication with the pressure activated switch which is configured to switch on when the animal places its weight on the mat.

In a further embodiment, the invention is a heated cabana for a pet comprising; a housing having an entrance and an open floor area for the pet to rest; a mat situated on the open floor area and having a pressure activated switch therein for activating the cabana, said switch being attached to a controller for controlling the level of pressure required activate switch; a heat lamp system in electrical communication with the pressure activated switch which is configured to switch on when the animal places its weight on the mat; and a thermostat for controlling the heat level and timing duration of the lamp.

In yet a further embodiment, the invention is a heated cabana for a pet comprising; a housing having an entrance and an open floor area for the pet to rest; a mat situated on the open floor area and having a pressure activated switch therein for activating the cabana, said switch being attached to a digital controller for controlling the level of pressure required activate switch; a heat lamp system including a fan in electrical communication with the pressure activated switch which is configured to switch on when the animal places its weight on the mat; and a digital thermostat for controlling the heat level and timing duration of the lamp.

### BRIEF DESCRIPTION OF THE DRAWINGS

FIG. 1 is a perspective view of the present invention.

FIG. 2 illustrates the circuit of the present invention.

FIG. 3 is an alterative embodiment of the invention without a roof.

### DESCRIPTION OF THE PREFERRED EMBODIMENT

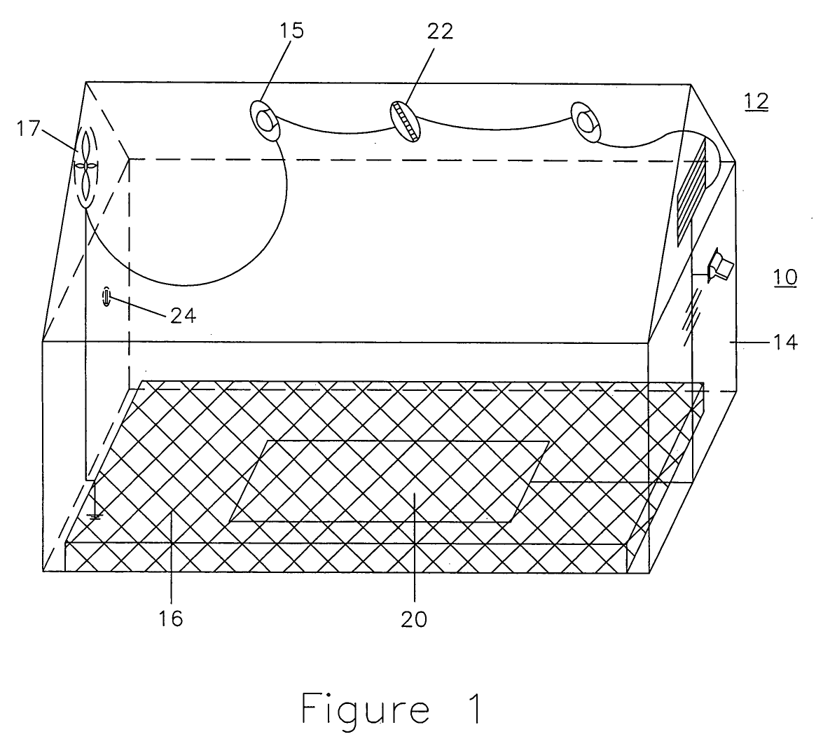

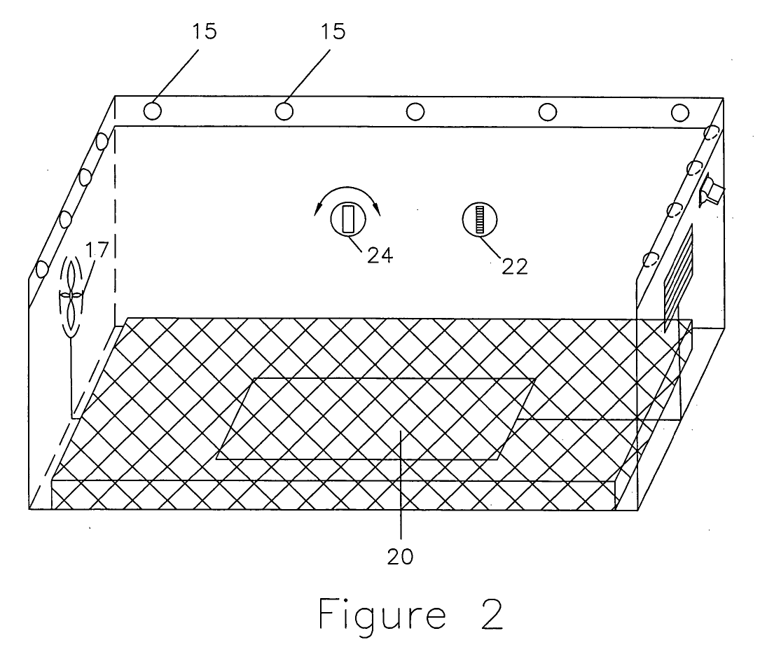

The present invention is directed to a pressure activated heat lamp and light for a pet. As shown in FIGS. 1 and 2, the invention comprises a pet cabana system 12. The system 10 comprises a housing structure 14 with an egress 16 for a pet to enter and lie down. The pet may be a dog or cat. The housing structure includes a central open floor are which supports a mat or pad

The system will have a pressure sensitive switch 20 within the pad 18 which will activate when the animal enters the cabana. The switch may be constructed from a variety of materials and utilize a variety of technologies. The switch 20 may comprise a contact switch or comprise a piezoelectric or pyroelectric material. The cabana will include heat lamps 14 and fan which will distribute heated air over the animal when the switch 20 is activated. The heat lams may comprise a plurality of lighting options and may be colored or simulate sunlight.

The system will preferably include a thermostat 22 which will be set to control the temperature of the cabana. The thermostat may either be digital or analog

The system will include a control 24 to set the weight required to activate the system. The control can be set in pounds or kilograms and will correspond with the weight of the animal or pet.

Finally, the system will have a timer to time out when the animal leaves the cabana. The cabana of the present invention can thus provide indoor or outdoor comfort and safety for a pet such as a cat or dog.

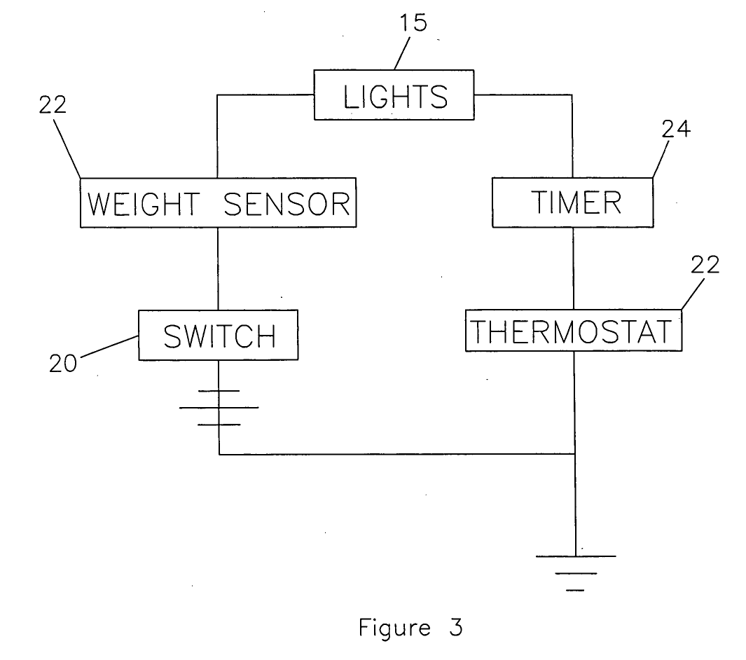

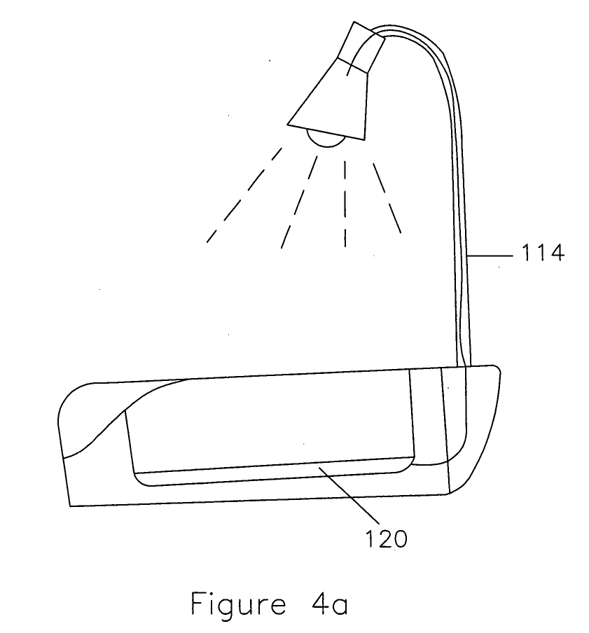

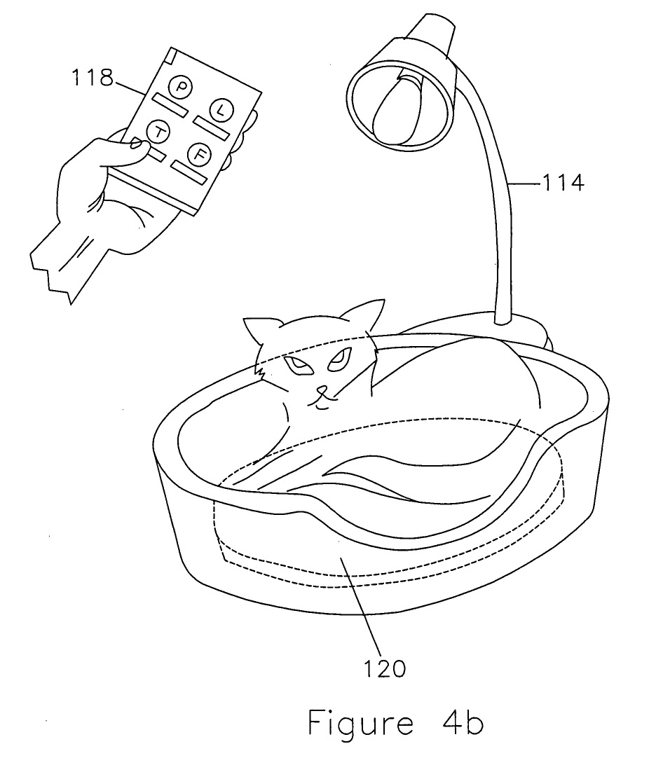

FIG. 3 illustrates the invention in an embodiment without a roof or lid. In this embodiment, the animal is in a open area with sides which support the lights and fan.

It is to be appreciated that the true nature and scope of the present invention is to be determined with reference to the claims appended hereto.

1. A heated area for a pet comprising;
a housing having an entrance and an open floor area for the pet to rest;
a mat situated on the open floor area and having a pressure activated switch therein for activating the cabana; and
a heat lamp system in electrical communication with the pressure activated switch which is configured to switch on when the animal places its weight on the mat.

2. The heated area for a pet of claim 1 further comprising a thermostat for controlling the heat level of the lamp.

3. The heated area of claim 2 further comprising a control mechanism to set the weight sensitivity of the mat.

4. The cabana of claim 1 wherein the heat lamp system is configured to remain on for a predetermined period after the animal exits the cabana.

5. A heated cabana for a pet comprising;
a housing having an entrance and an open floor area for the pet to rest;
a mat situated on the open floor area and having a pressure activated switch therein for activating the cabana, said switch being attached to a controller for controlling the level of pressure required activate switch;
a heat lamp system in electrical communication with the pressure activated switch which is configured to switch on when the animal places its weight on the mat; and
a thermostat for controlling the heat level and timing duration of the lamp.

6. A heated cabana for a pet comprising;
a housing having an entrance and an open floor area for the pet to rest;
a mat situated on the open floor area and having a pressure activated switch therein for activating the cabana, said switch being attached to a digital controller for controlling the level of pressure required activate switch;
a heat lamp system including a fan in electrical communication with the pressure activated switch which is configured to switch on when the animal places its weight on the mat; and
a digital thermostat for controlling the heat level and timing duration of the lamp.
